(19) United States
(12) Patent Application Publication
(10) Pub. No.: US 2022/0225568 A1
(43) Pub. Date: Jul. 21, 2022

(54) SYSTEM AND METHOD FOR DETERMINING A BROKEN GRAIN FRACTION

(71) Applicant: CLAAS Selbstfahrende Erntemaschinen GmbH, Harsewinkel (DE)

(72) Inventors: Torben Töniges, Bielefeld (DE); Frédéric Fischer, Arnsberg (DE); Boris Kettelhoit, Gütersloh (DE); Johann Witte, Fröndenberg (DE)

(73) Assignee: CLAAS Selbstfahrende Erntemaschinen GmbH, Harsewinkel (DE)

(21) Appl. No.: 17/576,035

(22) Filed: Jan. 14, 2022

(30) Foreign Application Priority Data
Jan. 21, 2021 (DE) 102021101219.8

(51) Int. Cl. A01D 41/127; G06T 7/00; G06T 7/62

(52) U.S. Cl. CPC A01D 41/1277; G06T 7/0002; G06T 2207/30188; G06T 2207/20084; G06T 2207/20081; G06T 7/62

(57) ABSTRACT

A system and method for determining a broken grain fraction of a quantity of grains is disclosed. The system includes at least one camera and a computing unit, with the camera configured to create an image of the quantity of grains, and with the computing unit configured to evaluate, using artificial intelligence, the image to determine broken grains in the image, and to determine, based on the broken grains, the broken grain fraction of the quantity of grains in the image.

### CROSS REFERENCE TO RELATED APPLICATIONS

This application claims priority under 35 U.S.C. § 119 to German Patent Application No. DE 102021101219.8 filed Jan. 21, 2021, the entire disclosure of which is hereby incorporated by reference herein.

### TECHNICAL FIELD

The invention relates to a system and method for determining a broken grain fraction of a quantity of grains.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Combine harvesters (also termed combines) are designed to harvest a variety of grain crops, and can perform reaping, threshing, gathering, and winnowing. Combines, such as in EP2742791B1, may include a camera and grain loss sensors.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 illustrates an agricultural harvester in one aspect.

FIG. 2 illustrates an example block diagram of the system.

FIG. 3 illustrates an image of grains.

FIG. 4 illustrates a flow diagram.

FIG. 5 illustrates another image of grains.

### DETAILED DESCRIPTION

In one or some embodiments, a system and method are disclosed to determine the broken grain fraction of a quantity of grains.

This may be achieved by a system for determining a broken grain fraction of a quantity of grains comprising at least one camera that is configured to create an image of the quantity of grains, and a computing unit that is configured to evaluate the image. The computing unit may be configured to use artificial intelligence to evaluate the image, such as determining broken grains in the image, and configured to determine, based on the determined broken grains in the image, the broken grain fraction of the quantity of grains in the image.

In one or some embodiments, the camera comprises any optical sensor that emits at least two dimensional sensor data. In one or some embodiments, the corresponding sensor data are termed an image. A camera may therefore be one or both a classic camera or a lidar sensor program.

In one or some embodiments, artificial intelligence comprises a model for recognizing objects in images. In one or some embodiments, the artificial intelligence may be trained with a plurality of images (e.g., supervised learning using tagged images). In so doing, the broken grains may be manually identified in the plurality of images (e.g., tagged in the plurality of images), and parameters of the model may be determined in training by a mathematical method so that the artificial intelligence can recognize broken grains in images. Various mathematical methods are contemplated. Alternatively, or in addition, whole grains may be recognized by artificial intelligence or by classic image processing, for example by watershed transformation. The broken grain fraction may then be determined in the images from the recognized grains and broken grains. Moreover, it is contemplated to use artificial intelligence for recognizing non-grain objects such as straw. The recognition of non-grain objects may prevent these objects from being recognized as grains in classic image processing.

In one or some embodiments, the artificial intelligence comprises a deep neural network which is also termed deep learning. Other architectures for creating artificial intelligence are contemplated.

In one or some embodiments, the broken grain fraction may be indicated as the fraction of broken grains of all recognized whole grains and broken grains in the images. To accomplish this, the whole grains and the broken grains may be counted. The broken grain fraction results from the number of broken grains divided by the sum of whole grains and broken grains. The advantage of this broken grain fraction is that it may be easier to determine.

Since the broken grains are generally smaller than the whole grains, the broken grain fraction may be indicated as the surface fraction. To this end, the surfaces of the whole grains and the broken grains in the images are determined for example as the number of pixels in digital images. The broken grain fraction then results from the sum of surfaces of broken grains divided by the sum of the surfaces of the whole grains and the broken grains.

Since the grains are three-dimensional, it may be desirable to output the broken grain fraction, such as a volume fraction. When using a camera that generates the three-dimensional sensor data as an image, for example a stereo camera or a lidar sensor, these data may be used to determine the volumes of the grains and broken grains. Alternatively, when two dimensional data are used, the volume of the broken grains and the whole grains may be approximated from the surfaces of the broken grains and the whole grains. Regardless, the output of the broken grain fraction may comprise any one, any combination, or all of an area fraction, a volume fraction, or a weight fraction. The approximation may depend on the type of grains. The type of grains may be manually specified or determined automatically from the images. Alternatively, the type of grains may be obtained from a farm management system, wherein the type of cultivated plants is saved in the farm management system for the site of use of the system. The broken grain fraction then results as the sum of the volumes of broken grains divided by the sum of the volumes of the whole grains and the broken grains.

Assuming a constant density, the broken grain fraction as a volume fraction is identical to a broken grain fraction as a mass fraction. The broken grain fraction may be output using the same method as the mass fraction.

In one or some embodiments, the camera is part of a mobile device, such as a smart phone or a combine. The use of a camera that is part of a mobile device enables flexible image capture. With a smart phone, the user may capture images of whole grains and broken grains at every location at which she/he is located, for example grain samples from a combine. A camera in a combine may be installed in the combine so that images of the harvested grains are automatically captured. For example, grains conveyed by a grain elevator into the grain tank may be automatically photographed.

In one or some embodiments, the computing unit is part of the mobile device (e.g., a smartphone with camera functionality). When the camera and computing unit are part of the same mobile device, the images may be locally evaluated.

In one or some embodiments, the computing unit is at a distance or separated from the mobile device. Beyond mobile devices such as smart phones or combines, frequently greater computing capacities may be made available more conveniently. The image captured by the camera in the mobile device may be, for example, transmitted wirelessly to the computing unit and evaluated there by the computing unit. The computing unit may, for example, be located in a computing center of a service provider. After analysis (e.g., determination of the broken grain fraction), the broken grain fraction and if applicable other evaluation results may then be returned to the mobile device.

In one or some embodiments, the system comprises a learning unit, wherein the learning unit is provided and configured to improve the artificial intelligence with the images. On the one hand, the images are evaluated by the artificial intelligence, on the other hand, the images are used to improve the artificial intelligence. For improvement, the images may be manually annotated (e.g., the broken grains in the image are identified or tagged, and the artificial intelligence may be trained therewith using the identified/tagged images).

In one or some embodiments, the learning unit is part of a computing unit remote from the mobile device. Since training artificial intelligence frequently may require considerable computing capacity, the learning unit, in one or some embodiments, may be part of a computer remote from the mobile device.

In one or some embodiments, the system is configured to output an indication of the broken grain fraction via an output interface, such as a display device. The broken grain fraction may be brought to the awareness of the user (such as the operator of the combine) and/or may be transmitted to other systems for further processing. For example, the broken grain fraction may be transmitted by a smart phone to a combine.

In one or some embodiments, the system includes a combine with at least one work assembly, such as a threshing system. The system may be configured to at least control or regulate one or more aspects (e.g., one or more control aspects) of the work assembly, such as one or more settings of the work assembly, based on the determined broken grain fraction. In one embodiment, the work assembly may be regulated directly by the computing unit. Alternatively, the computing unit may forward the broken grain fraction, or a value derived therefrom, to a regulation unit, which may, in turn, control or regulate the setting of the work assembly.

In one or some embodiments, the system comprises a base, wherein the base is configured to receive the grains, such as in the same orientation. Further, the camera may be positioned and thereby configured to photographic the grains on the base. In one or some embodiments, the base offers a defined background. In this way, the images obtained of the grains on the base makes it possible to better recognize the grains and broken grains and therefore to better determine the broken grain fraction. In one or some embodiments, an equal orientation means that the longest axis of the grains are oriented parallel. To this end, the base may have elevations on which the grains may be oriented.

In one or some embodiments, the system is configured to reduce or to exclude accumulations of grains when evaluating the images. When grains accumulate, some grains may partially cover other grains, which may make it difficult to recognize or identify broken grains. By excluding identified accumulations, only individual layers of grains and broken grains may be evaluated, thereby improving the determination of the broken grain fraction.

Moreover, the invention relates to a method for determining a broken grain fraction of a quantity of grains, wherein the method is performed using a camera and a computing unit, wherein the camera creates an image of the grains and transmits the image to the computing unit. In turn, the computing unit evaluates the image with artificial intelligence, which determines broken grains in the image. In turn, the computing unit determines, based on the determined broken grains in the image, the broken grain fraction of the quantity of grains in the image.

In one or some embodiments, the image is transmitted by the camera to a learning unit, wherein the learning unit improves the artificial intelligence with the image. The image may be annotated or tagged, and the artificial intelligence is trained by the learning unit with the annotated or tagged image.

In one or some embodiments, based on the broken grain fraction, a work assembly, such as a combine, may be controlled or regulated. Control or regulation may be performed in one of several ways. In one way, control or regulation may be performed entirely automatically without operator intervention. For example, based on the determined broken grain fraction, the operation of the work assembly may be automatically modified (e.g., in order to reduce the broken grain fraction). Alternatively, the determined broken grain fraction and/or the recommended control or regulation (determined by the computing unit) may be output to an operator for the operator to confirm prior to modifying operation of the work assembly.

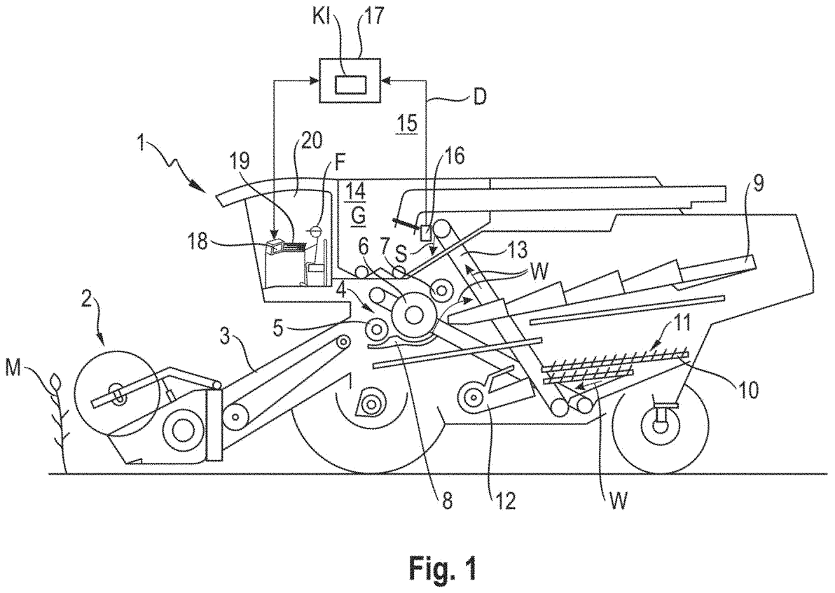

Referring to the figures, FIG. 1 shows a schematic representation of a self-propelling agricultural harvester (e.g., combine 1). In the shown exemplary embodiment, the agricultural harvester is a combine 1. Alternatively, other types of agricultural harvesters are contemplated. The system 15 comprises (or consists of) two components, a camera 16 and a computing unit 17. Before discharging grains S into a grain tank 14, the camera 16 generates one or more images or a series of images of the grains S. In one embodiment, the camera 16 is a digital color camera, and the images are two-dimensional colored images. The images or series of images are supplied or transmitted to the computing unit 17.

Computing unit 17 may comprise any type of computing functionality, such as at least one processor 22 (which may comprise a microprocessor, controller, PLA, or the like) and at least one memory 23. The memory 23 may comprise any type of storage device (e.g., any type of memory). Though the computing unit 17 is depicted with a single processor 22 and a single memory 23 as separate elements, they may be part of a single machine, which includes a microprocessor (or other type of controller) and a memory. Further, the computing unit 17 may include more than one processor 22 and/or more than one memory 23.

The computing unit 25 is merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The computing unit 17, using software and/or hardware, is configured to manifest artificial intelligence KI. For example, the artificial intelligence KI may be stored in memory 23 and loaded into processor 22 and may comprise an application comprising object recognition (e.g., recognizing broken grains). Specifically, in the computing unit 17, the images or series of images may be analyzed by an artificial intelligence KI to recognize the broken grains. Based on the analytical results, the setting parameters for the work assembly(ies) of the combine 1 may be automatically or manually modified or changed by the computing unit 17. In one or some embodiments, the modification or change is configured to modify operation of the work assembly (ies) in order to obtain very uniform quality of the harvested material G in the grain tank 14 (e.g., to obtain quality of the harvested material G in the grain tank 14 within a predetermined deviation).

Harvested material M is picked up or collected with the known means of a cutting unit 2 and an inclined conveyor 3 by the combine 1 and processed with the known work assemblies such as a threshing unit 4 consisting of a pre-accelerator drum 5, a threshing drum 6, a turning drum 7, a threshing concave 8, and a separating device consisting of a shaker 9, a returning area 10 and a cleaning device 11 with a blower 12 in order to obtain the harvested material G. Along the harvested material transport path W, the flow of harvested material S is fed via a grain elevator 13 to the grain tank 14.

In one or some embodiments, the system 15 for determining a broken grain fraction comprises a camera 16 and a computing unit 17 that are connected (e.g., wired and/or wirelessly) to each other by a data line D. In the example of the combine 1, the camera 16 is arranged or positioned in the area of the elevator head of the grain elevator 13. The computing unit 17 is installed in the combine 1. It is also contemplated to use an external computing unit and configure the data line D as a radio path (e.g., a long distance wireless communication path).

The images, or series of images, or the analytical results fed to the computing unit 17 may in turn be forwarded or transmitted by the computing unit 17 to a user interface comprising (or consisting of) a display 18 and an operating device 19 in the driver's cab 20 of the combine 1. There, the images or series of images may, for example, be displayed to a user F of the self-propelling agricultural harvesting machine (e.g., combine 1) so that she/he may execute, for example, a manual input in order to change or optimize the setting parameters of any one, any combination, or all of the work assemblies 4, 5, 6, 7, 8, 9, 10, 11, 12. A change to the setting parameters of any one, any combination, or all of the work assemblies 4, 5, 6, 7, 8, 9, 10, 11, 12 may also be performed automatically by the computing unit 17 (such as by control system 24 discussed below) depending on the default setting in the operating device 19 (e.g., one or more rules may be stored in computing unit 17 in order to determine the change to the setting parameters based on the determined broken grain fraction).

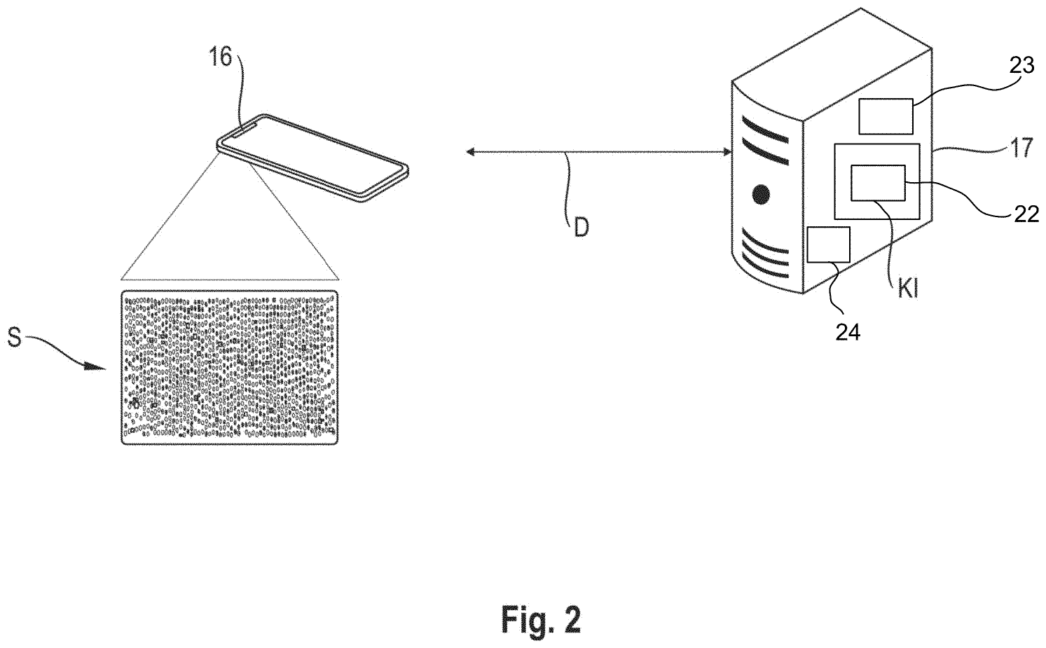

FIG. 2 shows an alternative system according to one aspect. The system 15 comprises a camera 16, such as a smart phone, and a computing unit 17, such as an external server (e.g., a server sitting on the Internet) so that the camera 16 (in or on the combine 1) and the computing unit 17 reside on separate electronic devices and a physically separate as well. The camera may comprise one or both of a digital color camera and a lidar. The sensor data of the color camera and the lidar may be fused in the smart phone or in the computing unit 17 into a three-dimensional image. The user may take an image of grains S with the camera 16. In turn, the image may be forwarded via the data line D (which may be wired and/or wireless) to the computing unit 17. The computing unit 17 may be configured to evaluate the image, such as an artificial intelligence KI within the computing unit 17 configured to evaluate broken grains in the image. In turn, the computing unit 17 may then determine, based on the evaluated broken grains, the broken grain fractions of the volume of grains in the image. The result may be transmitted via the data line D back to the smart phone and displayed to the user. Optionally, the image may be used in the server to improve the artificial intelligence. To this end, a learning unit may be located in the external server in addition to the artificial intelligence KI. In one or some embodiments, the image may be manually annotated or tagged (e.g., with identification in the image of broken grains) and transmitted to the learning unit. The learning unit, in turn, may use the image to train the artificial intelligence KI. In particular, example images, which may comprises templates or exemplars, of the broken grains may be used to train the artificial intelligence KI.

FIG. 2 further includes control system 24 (alternatively termed a control unit). Control system 24 is configured to control any one, any combination, or all of the work assemblies 4, 5, 6, 7, 8, 9, 10, 11, 12. In one or some embodiments, control system 24 may be part of computing unit 17. Alternatively, control system 24 may be separate from and in communication with computing unit 17 (e.g., in order to receive the broken grain fraction for generating the one or more control signals to modify operation of the work assemblies 4, 5, 6, 7, 8, 9, 10, 11, 12).

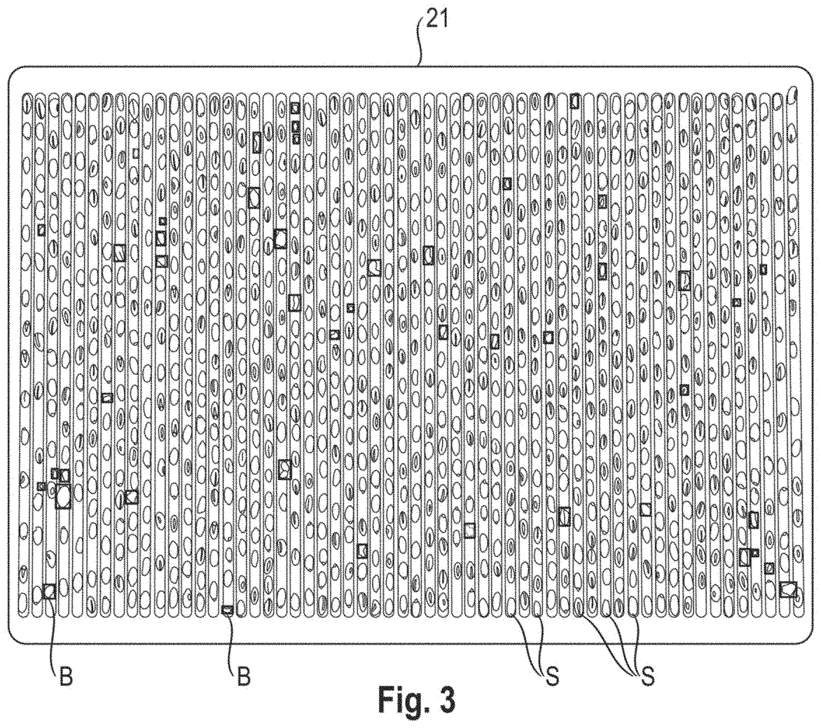

FIG. 3 shows an image of grains S. The grains are spread on a base 21 in this example. Broken grains B are identified in this image with a rectangle. The artificial intelligence KI may be trained with such images. If a similar image of grains S is transmitted to the computing unit 17, the artificial intelligence KI, based on its previous training using other images, may recognize the broken grains B therein and may identify them.

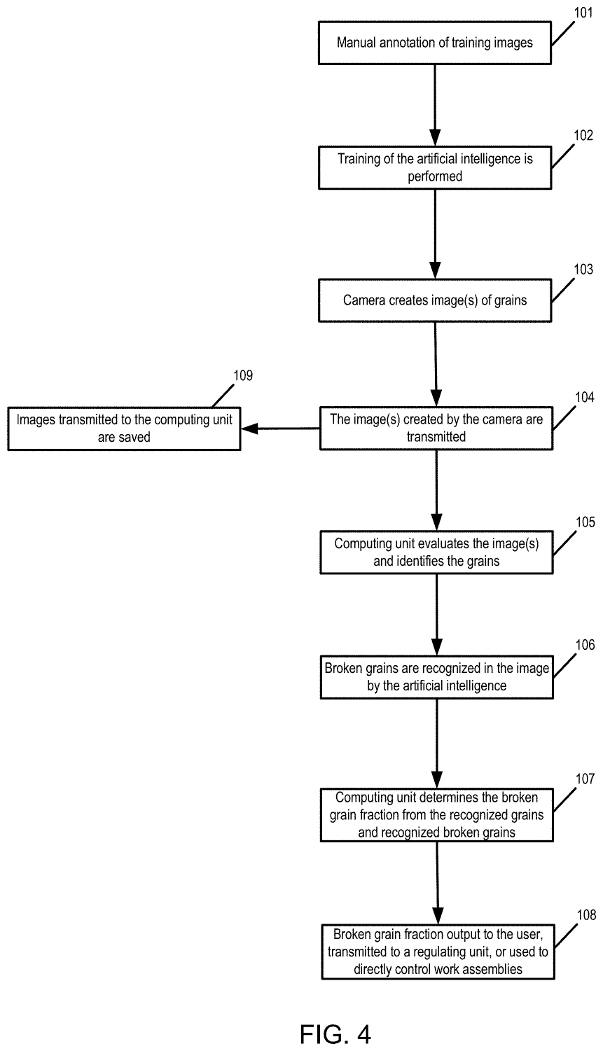

FIG. 4 shows a flow diagram of a method according to one embodiment. Before the training, at 101, there may comprise a manual annotation of training images. At 102, training of the artificial intelligence is performed with these images. The computing unit may perform the training of the artificial intelligence. In the method according to one aspect, at 103, a camera creates image(s) of grains 103. At 104, the image(s) created by the camera are transmitted by the camera to the computing unit. At 105, the computing unit evaluates the image(s) and recognizes or identifies the grains. This may be performed by classic image processing, for example by watershed transformation, or by using artificial intelligence. Then, at 106, broken grains are recognized in the image by the artificial intelligence. At 107, the computing unit determines the broken grain fraction from the recognized grains and recognized broken grains. At 108, the broken grain fraction may be output to the user, transmitted to a regulating unit, or used to directly control work assemblies. Optionally, at 109, the images transmitted to the computing unit are saved to use them to improve the artificial intelligence.

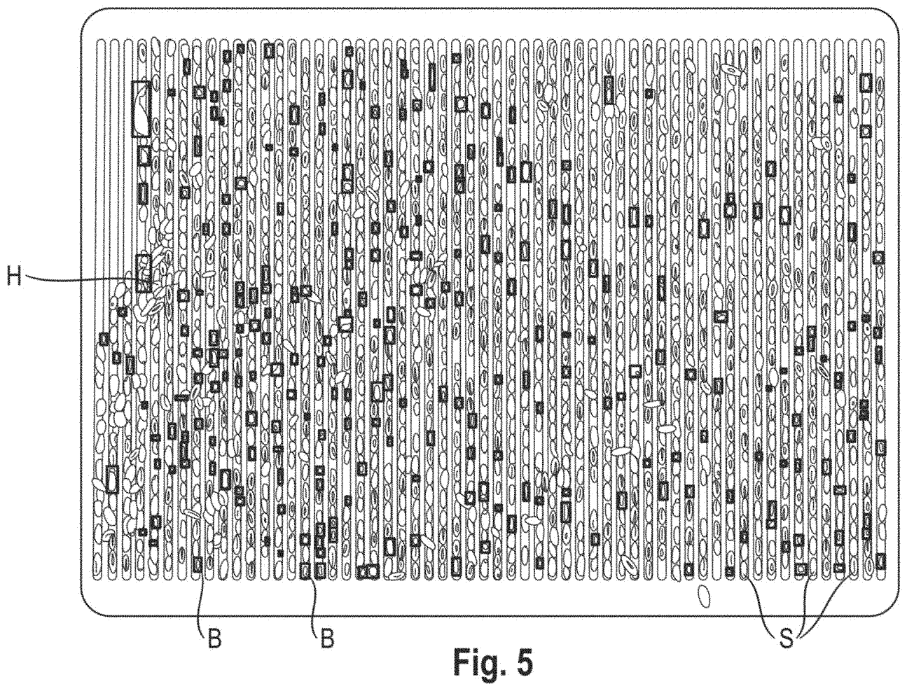

FIG. 5 shows another image of grains S. As in FIG. 3, broken grains B are identified with rectangles. On the left edge of the image, there is an accumulation H of many grains that partially cover each other. Since this area is difficult for the artificial intelligence to evaluate, this area is eliminated in the evaluation of the image. The broken grain fraction in the remaining image (e.g., separate from accumulation H) may therefore be determined. In one or some embodiments, the accumulation H of the grains may first be identified in particular portion(s) of a respective image. After which, the respective image may be modified, such as edited to remove the particular portion(s) of the respective image, prior to transmitting the respective image to the artificial intelligence for evaluation. As such, the artificial intelligence may then evaluate the respective image without the areas of the image that may be difficult for the artificial intelligence to evaluate.

Further, it is intended that the foregoing detailed description be understood as an illustration of selected forms that the invention can take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Combine
2 Cutting unit
3 Inclined conveyor
4 Threshing unit
5 Pre-accelerated drum
6 Threshing drum
7 Turning drum
8 Threshing concave
9 Shaker
10 Returning area
11 Cleaning device
12 Fan
13 Grain elevator
14 Grain tank
15 System
16 Camera
17 Computing unit
18 Display device
19 Operating device
20 Driver's cab
21 Base
22 Processor
23 Memory
24 Control system
KI Artificial intelligence
M Harvested material
S Grains
G Harvested material
W Harvested material transport path
F Operator
H Accumulation
101 Annotation
102 Training
103 Create image
104 Transfer image
105 Evaluate image
106 Recognize broken grain
107 Determine broken grain fraction
108 Transmit results
109 Save image

1. A system for determining a broken grain fraction of a quantity of grains comprising:
at least one camera configured to create an image of the quantity of grains;
a computing unit in communication with the camera and configured to determine the broken grain fraction of the quantity of grains in an image by:
using artificial intelligence to analyze the image to determine broken grains in the image; and
determine, based on the determined broken grains in the image, the broken grain fraction of the quantity of grains in the image.

2. The system of claim 1, wherein the artificial intelligence comprises a trained deep neural network.

3. The system of claim 1, wherein the computing unit is configured to determine the broken grain fraction as one or more of an area fraction, volume fraction, or weight fraction.

4. The system of claim 1, wherein the at least one camera is part of a mobile device.

5. The system of claim 4, wherein the mobile device is associated with a smartphone.

6. The system of claim 4, wherein the mobile device is associated with a combine.

7. The system of claim 4, wherein both of the at least one camera and the computing unit are part of the mobile device.

8. The system of claim 4, wherein the computing unit is remote from the mobile device.

9. The system of claim 1, further comprising a learning unit configured to further train the artificial intelligence (KI) with the image.

10. The system of claim 9, wherein the at least one camera is part of a mobile device; and
wherein the learning unit is part of the computing unit remote from the mobile device.

11. The system of claim 1, further comprising a display device configured to output the broken grain fraction.

12. The system of claim 1, further comprising:
a threshing system; and
a control system in communication with the computing unit and configured to control at least aspect of the threshing system based on the broken grain fraction.

13. The system of claim 1, further comprising a base, wherein the base is configured to receive the grains in a same orientation; and
wherein the at least one camera is configured to photograph the grains on the base.

14. The system of claim 1, wherein the computing unit is configured to identify accumulations of grains in a respective image and to exclude the identified accumulations of grains when evaluating the image using artificial intelligence.

15. A method for determining a broken grain fraction of a quantity of grains, the method comprising:
obtaining, using at least one camera, an image of the quantity of grains;
transmitting, from the at least one camera to a computing unit, the image;
evaluating, using artificial intelligence of the computing unit, the image to determine broken grains in the image; and
determining, by the computing unit and based on the determined broken grains in the image, the broken grain fraction of the quantity of grains in the image.

16. The method of claim 15, further comprising using, by a learning unit, the image to further train the artificial intelligence.

17. The method of claim 15, further comprising controlling at least one work assembly using the broken grain fraction.

18. The method of claim 17, wherein the at least one work assembly comprises a threshing system; and
wherein a control system, based on the broken grain fraction, modifies at least one control aspect of the threshing system in order modify operation of the threshing system and in turn modify the broken grain fraction.

19. The method of claim 15, wherein the at least one camera and the computing unit are part of a same electronic device.

20. The method of claim 15, wherein the at least one camera and the computing unit are resident on separate electronic devices;
wherein the computing unit comprises a server on an Internet;
wherein the image is transmitted from the at least one camera to the server on the Internet in order for the computing unit to evaluate, using the artificial intelligence of the computing unit, the image to determine broken grains in the image.
